(19) United States
(12) Patent Application Publication
(10) Pub. No.: US 2024/0193014 A1
(43) Pub. Date: Jun. 13, 2024

(54) METHODS AND APPARATUSES FOR REPORTING EVENT RELATED INFORMATION

(71) Applicant: LENOVO (BEIJING) LIMITED, Beijing (CN)

(72) Inventors: Le YAN, Shanghai (CN); Lianhai WU, Beijing (CN); Mingzeng DAI, Shanghai (CN); Congchi ZHANG, Shanghai (CN); Yibin ZHUO, Beijing (CN)

(21) Appl. No.: 18/556,584

(22) PCT Filed: Apr. 22, 2021
(86) PCT No.: PCT/CN2021/089004

§ 371 Date: Oct. 20, 2023

(51) Int. Cl. G06F 9/54; H04W 24/04

(52) U.S. Cl. CPC G06F 9/542; H04W 24/04

(57) ABSTRACT

The present disclosure relates to a methods and apparatuses for reporting event related information. One embodiment of the present disclosure provides a method performed by a user equipment (UE), which includes: detecting a first event associated with a source secondary cell group (SCG) or a target SCG; detecting a second event associated with a master cell group (MCG); and storing event related information associated with the first event and the second event for transmission to the network.

### TECHNICAL FIELD

The present disclosure relates to wireless communication technologies, and more particularly, the subject disclosure relates to methods and apparatuses for reporting event related information.

### BACKGROUND OF THE INVENTION

In a multi-RAT (radio access technology) dual (MR)-dual connectivity (DC) system, the event includes secondary cell group (SCG) failure and master cell group (MCG) failure. Currently, the UE is required to report the SCG failure related information or report the MCG failure related information.

Under some scenarios, only SCG failure related information or only MCG failure related information may not be sufficient enough to let the network know the detailed failure experienced at UE side. Therefore, methods and apparatuses for reporting event related information need to be improved.

### SUMMARY

One embodiment of the present disclosure provides a method performed by a user equipment (UE), which includes: detecting a first event associated with a source secondary cell group (SCG) or a target SCG; detecting a second event associated with a master cell group (MCG); and storing event related information associated with the first event and the second event for transmission to the network.

In one embodiment of the present disclosure, the method further includes: initiating a radio resource control (RRC) re-establishment procedure towards a re-establishment network node; and transmitting the event related information to the re-establishment network node.

In one embodiment of the present disclosure, the first event is a first failure associated with the source SCG.

In one embodiment of the present disclosure, the event related information at least includes the following parameters:
1) an identifier of a failed primary cell (PCell) in the MCG,
2) a type of the second event,
3) a first time period from an occurrence of the first event to an occurrence of the second event;
4) a second time period from the occurrence of the second event to transmission of the event related information; and
5) measurement results for the MCG and/or the source SCG when the first event and/or the second event are detected.

In one embodiment of the present disclosure, the event related information further includes an identifier of a failed primary secondary cell (PSCell) in the source SCG and a type of the first event.

In one embodiment of the present disclosure, the method further includes: receiving a RRC message for primary secondary cell (PSCell) change before an occurrence of the first event and/or an occurrence of the second event.

In one embodiment of the present disclosure, the first event is an ongoing random access channel (RACH) procedure from a source PSCell to a target PSCell being stopped due to the second event.

In one embodiment of the present disclosure, the event related information at least includes the following parameters:
1) an identifier of a failed primary cell (PCell) in the MCG;
2) a type of the second event;
3) an identifier of the source PSCell;
4) an identifier of the target PSCell;
5) an indication indicating the RACH procedure is stopped;
6) a third time period from reception of the RRC message to the occurrence of the second event;
7) a fourth time period from the occurrence of the second event to the occurrence of the first event;
8) a fifth time period from the occurrence of the first event to transmission of the event related information; and
9) measurement results for the MCG and/or the source SCG when the first event and/or the second event are detected.

In one embodiment of the present disclosure, the first event is a PSCell change failure occurred during a PSCell change procedure, or an SCG failure occurred shortly after a successful PSCell change from the source PSCell to the target PSCell.

In one embodiment of the present disclosure, the event related information at least includes the following parameters:
1) an identifier of a failed primary cell (PCell) in the MCG;
2) a type of the second event;
3) an identifier of the source PSCell;
4) an identifier of the failed PSCell;
5) a type of the first event associated with the target SCG;
6) a sixth time period from reception of the RRC message to the occurrence of the first event;
7) a seventh time period from the occurrence of the first event to the occurrence of the second event;
8) an eighth time period from the occurrence of the second event to transmission of the event related information; and
9) measurement results for the MCG and/or the source SCG when the first event and/or the second event are detected.

In one embodiment of the present disclosure, the second event is a failure associated with the MCG.

In another embodiment of the present disclosure provides a method performed by a network node, which includes: receiving event related information from a user equipment (UE), wherein the event related information is related to a first event associated with a source secondary cell group (SCG) or a target SCG related to the UE, and is also related to a second event associated with a master cell group (MCG) related to the UE; and modifying one or more SCG configurations associated with the UE, wherein the one or more SCG configurations include at least one of the following: signalling radio bearer (SRB) configuration; data radio bearer (DRB) configuration; a threshold for triggering PSCell change, PSCell modification, or PSCell release; and RACH configuration for target PSCell.

In one embodiment of the present disclosure, the method further includes: receiving the event related information from a re-establishment network node via interfaces between radio access network (RAN) nodes or via interfaces between RAN nodes and a core network.

In one embodiment of the present disclosure, the method further includes: modifying one or more MCG configurations associated with the UE, wherein the one or more MCG configurations include at least one of the following: signalling radio bearer (SRB) configuration; data radio bearer (DRB) configuration; and a threshold for triggering PCell change or PCell modification.

In one embodiment of the present disclosure, the method further includes: transmitting the event related information to a master node, a source secondary node, and/or a target secondary node.

In one embodiment of the present disclosure, the first event is a first failure associated with the source SCG.

In one embodiment of the present disclosure, the event related information at least includes the following parameters:
1) an identifier of a failed primary cell (PCell) in the MCG;
2) a type of the second event;
3) a first time period from an occurrence of the first event to an occurrence of the second event;
4) a second time period from the occurrence of the second event to transmission of the event related information; and
5) measurement results for the MCG and/or the source SCG when the first event and/or the second event are detected.

In one embodiment of the present disclosure, the event related information further includes an identifier of a failed primary secondary cell (PSCell) in the source SCG and a type of the first event.

In one embodiment of the present disclosure, a RRC message for primary secondary cell (PSCell) change is transmitted before an occurrence of the first event and/or an occurrence of the second event.

In one embodiment of the present disclosure, the first event is an ongoing random access channel (RACH) procedure from a source PSCell to a target PSCell being stopped due to the second event.

In one embodiment of the present disclosure, the event related information at least includes the following parameters:
1) an identifier of a failed primary cell (PCell) in the MCG;
2) a type of the second event;
3) an identifier of the source PSCell;
4) an identifier of the target PSCell;
5) an indication indicating the RACH procedure is stopped;
6) a third time period from reception of the RRC message to the occurrence of the second event;
7) a fourth time period from the occurrence of the second event to the occurrence of the first event;
8) a fifth time period from the occurrence of the first event to transmission of the event related information; and
9) measurement results for the MCG and/or the source SCG when the first event and/or the second event are detected.

In one embodiment of the present disclosure, the first event is a PSCell change failure occurred during a PSCell change procedure, or an SCG failure occurred shortly after a successful PSCell change from the source PSCell to the target PSCell.

In one embodiment of the present disclosure, the event related information at least includes the following parameters:
1) an identifier of a failed primary cell (PCell) in the MCG;
2) a type of the second event;
3) an identifier of the source PSCell;
4) an identifier of the failed PSCell;
5) a type of a first event associated with the target SCG;
6) a sixth time period from reception of the RRC message to the occurrence of the first event;
7) a seventh time period from the occurrence of the first event to the occurrence of the second event;
8) an eighth time period from the occurrence of the second event to transmission of the event related information; and
9) measurement results for the MCG and/or the source SCG when the first event and/or the second event are detected.

In one embodiment of the present disclosure, the second event is a failure associated with the MCG.

In still another embodiment of the present disclosure provides a method performed by a network node, which includes: receiving event related information from a user equipment (UE), wherein the event related information is associated with a first event associated with a source secondary cell group (SCG) or a target SCG related to the UE, and is also associated with a second event associated with a master cell group (MCG) related to the UE; and transmitting the event related information to a first network node that provides the MCG associated with UE, and/or a second network node that provides either the source SCG or the target SCG associated with the UE.

In still another embodiment of the present disclosure provides a processor; a transceiver coupled to the processor, wherein the processor is configured to: detect a first event associated with a source secondary cell group (SCG) or a target SCG; detect a second event associated with a master cell group (MCG); and store event related information associated with the first event and the second event for transmission to the network.

### BRIEF DESCRIPTION OF THE DRAWINGS

FIG. 1 illustrates a MR-DC system with 5G core network (5GC) 100 according to some embodiments of the present disclosure.

FIG. 2 illustrates a flow chart of SN change initiated by the MN according to some embodiments of the present disclosure.

FIG. 3 illustrates a flow chart of SN change initiated by the SN according to some embodiments of the present disclosure.

FIG. 4 illustrates a flow chart for reporting event related information according to some embodiments of the present disclosure.

FIG. 5 illustrates another flow chart for reporting event related information according to some embodiments of the present disclosure.

FIG. 6 illustrates still another flow chart for reporting event related information according to some embodiments of the present disclosure.

FIG. 7 illustrates yet another flow chart for reporting event related information according to some embodiments of the present disclosure.

FIG. 8 illustrates yet another flow chart for reporting event related information according to some embodiments of the present disclosure.

FIG. 9 illustrates a method performed by a UE for reporting event related information according to some embodiments of the present disclosure.

FIG. 10 illustrates a block diagram of an apparatus according to some embodiments of the present disclosure.

### DETAILED DESCRIPTION

The detailed description of the appended drawings is intended as a description of the currently preferred embodiments of the present invention, and is not intended to represent the only form in which the present invention may be practiced. It should be understood that the same or equivalent functions may be accomplished by different embodiments that are intended to be encompassed within the spirit and scope of the present invention.

While operations are depicted in the drawings in a particular order, persons skilled in the art will readily recognize that such operations need not be performed in the particular order shown or in sequential order, or that all illustrated operations be performed, to achieve desirable results, sometimes one or more operations can be skipped. Further, the drawings can schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

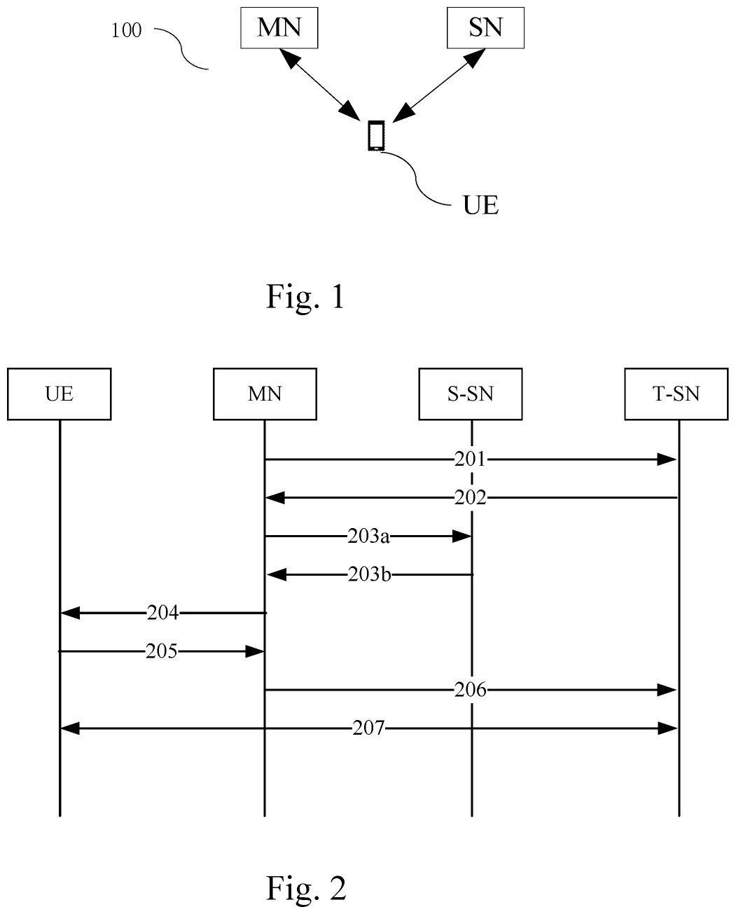

FIG. 1 illustrates a MR-DC system with 5GC 100 according to some embodiments of the present disclosure. The MR-DC system 100 includes a UE, a master node (MN), and a secondary node (SN). The UE is configured with a master cell group (MCG), which is a group of serving cells associated with the MN, including a primary cell (PCell) and optionally one or more secondary cells (SCells). The UE is also configured with a secondary cell group (SCG), which is a group of serving cells associated with the SN, including a primary secondary cell (PSCell) and optionally one or more SCells.

The UEs may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to an embodiment of the present disclosure, the UEs may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments, the UEs include wearable devices, such as smart watches, fitness bands, optical head-mounted displays, or the like. Moreover, the UEs may be referred to as a subscriber unit, a mobile phone, a mobile station, a user, a terminal, a mobile terminal, a wireless terminal, a fixed terminal, a subscriber station, a user terminal, or any device described using other terminology used in the art. The UEs may communicate directly with the MN and the SN via uplink communication signals.

The MN and the SN may be distributed over a geographic region. In certain embodiments, the MN and the SN may also be referred to as an access point, an access terminal, a base, a macro cell, a Node-B, an enhanced Node B (eNB), a gNB, a Home Node-B, a relay node, or any device described using other terminology used in the art.

The MR-DC system 100 is compatible with any type of network that is capable of sending and receiving wireless communication signals. For example, the MR-DC system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3rd generation partnership project (3GPP)-based network, a 3GPP 5G network, a satellite communications network, a high altitude platform network, and/or other communications networks.

In one embodiment, the MR-DC system 100 is compatible with the 5G NR of the 3GPP protocol, wherein the MN and the SN transmit data using an OFDM modulation scheme on the downlink and the UE transmits data on the uplink using discrete fourier transform-spread-orthogonal frequency division multiplexing (DFT-S-OFDM) or cyclic prefix-orthogonal frequency division multiplexing (CP-OFDM) scheme. More generally, the MR-DC system 100 may implement some other open or proprietary communication protocols, for example, WiMAX, among other protocols. Next generation radio access network (NG-RAN) supports a MR-DC operation. In a MR-DC scenario, a UE with multiple transceivers may be configured to utilize resources provided by two different nodes connected via non-ideal backhauls. Wherein one node may provide new radio (NR) access and the other one node may provide either Evolved Universal Terrestrial Radio Access (E-UTRA) or NR access. One node may act as a master node (MN) and the other node may act as a secondary node (SN). The MN and SN are connected via a network interface (for example, an Xn interface or an X2 interface as specified in 3GPP standard documents), and at least the MN is connected to the core network.

It should be noted that the MR-DC system in the present disclosure includes any MR-DC cases, which includes NR-NR DC, EN-DC (E-UTRAN New Radio—Dual Connectivity), NGEN-DC (next generation EN-DC), NE-DC (NR—E-UTRA Dual Connectivity). This disclosure is applied for a multi-radio dual connectivity (MR-DC) scenario and/or a long term evolution (LTE)-LTE DC scenario.

FIG. 2 illustrates a flow chart of SN change initiated by the MN according to some embodiments of the present disclosure.

FIG. 2 includes four different components, UE refers to a user equipment (UE), MN refers to a MN, S-SN refers to a source SN, and T-SN refers to a target SN. MN may refer to a radio access node that provides a control plane connection to the core network. In an embodiment of the present disclosure, in the E-UTRA-NR Dual Connectivity (EN-DC) scenario, MN may be an eNB. In another embodiment of the present disclosure, in the LTE-LTE DC scenario, MN may be an eNB. In another embodiment of the present disclosure, in the next generation E-UTRA-NR Dual Connectivity (NGEN-DC) scenario, MN may be an ng-eNB. In yet another embodiment of the present disclosure, in the NR-E-UTRA Dual Connectivity (NE-DC) scenario or the NR-NR Dual Connectivity (NR-DC) scenario, MN may be a gNB. S-SN or T-SN may refer to a radio access node without a control plane connection to the core network but providing additional resources to UE. In an embodiment of the present disclosure, in the EN-DC scenario, S-SN or T-SN may be an en-gNB. In another embodiment of the present disclosure, in the LTE-LTE DC scenario, S-SN or T-SN may be an eNB. In another embodiment of the present disclosure, in the NE-DC scenario, S-SN or T-SN may be an ng-eNB. In yet another embodiment of the present disclosure, in the NR-DC scenario or the NGEN-DC scenario, S-SN or T-SN may be a gNB.

In step 201, the MN initiates the SN change by transmitting a SN addition request to the target SN, which requests the target SN to allocate resources for the UE by means of the SN Addition procedure. The MN may include measurement results related to the target SN.

In step 202, the target SN transmits an acknowledge (ACK) to the SN addition request to the MN. If data forwarding is needed, the target SN provides data forwarding addresses to the MN. The target SN includes the indication of the full or delta RRC configuration.

If the allocation of target SN resources is successful, in step 203a, the MN transmits a SN Release request to the source SN, to release the source SN resources, which also includes a cause indicating SCG mobility. In step 203b, the source SN transmits an ACK to the SN Release request. The reception of the SN release request message triggers the source SN to stop providing user data to the UE.

In step 204, the MN transmits a message to the UE, which triggers the UE to apply the new configuration. The MN indicates the new configuration to the UE in the MN RRC reconfiguration message including the target SN RRC reconfiguration message. If MN is an eNB or ng-eNB that is connected to EPC or 5GC, the message may be a RRC Connection reconfiguration message. If MN is a gNB or en-gNB, the message may be a RRC reconfiguration message.

The UE applies the new configuration, and in step 205, the UE sends the MN RRC reconfiguration complete or RRC Connection reconfiguration complete message, including the SN RRC response message for the target SN, if needed.

In step 206, if the RRC (connection) reconfiguration procedure is successful, the MN informs the target SN via SN reconfiguration complete message with the included SN RRC response message for the target SN, if received from the UE.

In step 207, the UE synchronizes to the target SN.

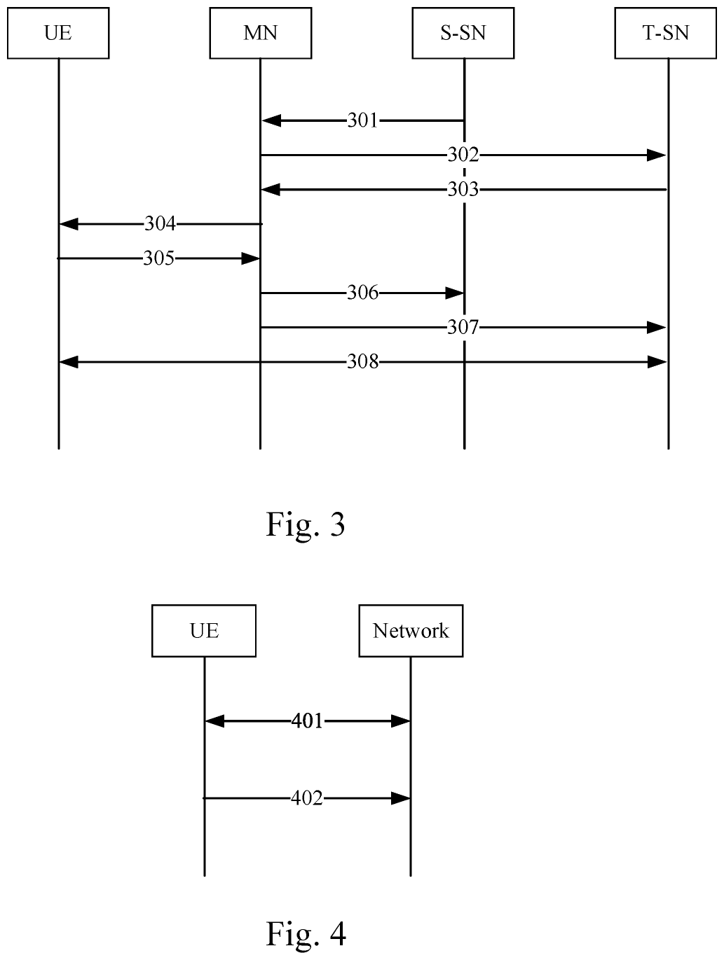

FIG. 3 illustrates a flow chart of SN change initiated by the SN according to some embodiments of the present disclosure.

In step 301, the source SN initiates the SN change procedure by sending the SN change required message to the MN, which contains a candidate target node ID, i.e., the ID of the target SN, and may include the SCG configuration, to support delta configuration, and measurement results related to the target SN.

In step 302, the MN requests the target SN to allocate resources for the UE by transmitting a SN addition request to the target SN, which includes the measurement results related to the target SN received from the source SN. In step 303, the target SN transmits an ACK to the SN addition request to the MN. If data forwarding is needed, the target SN provides data forwarding addresses to the MN. The target SN includes the indication of the full or delta RRC configuration.

In step 304, the MN transmits a message to the UE, which triggers the UE to apply the new configuration. The MN indicates the new configuration to the UE in the MN RRC reconfiguration message including SN RRC reconfiguration message generated by the target SN. If MN is an eNB or ng-eNB that is connected to EPC or 5GC, the message may be a RRC Connection reconfiguration message. If MN is a gNB or en-gNB, the message may be a RRC reconfiguration message. The UE applies the new configuration, and in step 305, the UE sends the MN RRC reconfiguration complete message or RRC Connection reconfiguration complete, including the SN RRC response message for the target SN, if needed.

If the allocation of target SN resources is successful, in step 306, the MN confirms the change of the source SN. If data forwarding is needed the MN provides data forwarding addresses to the source SN. If direct data forwarding is used for SN terminated bearers, the MN provides data forwarding addresses as received from the target SN to source SN. Reception of the SN Change Confirm message triggers the source SN to stop providing user data to the UE and, if applicable, to start data forwarding.

In step 307, if the RRC (connection) reconfiguration procedure is successful, the MN informs the target SN via SN Reconfiguration Complete message with the included SN RRC response message for the target SN, if received from the UE.

In step 308, the UE performs a RACH process, to synchronize to the target SN.

FIG. 4 illustrates a flow chart for reporting event related information according to some embodiments of the present disclosure.

In step 401, the network transmits the RRC reconfiguration message to the UE, and after receiving the RRC reconfiguration message, the UE performs reconfiguration based on the received message. When the UE has experienced an SCG failure, in step 402, the UE transmits the SCGFailureInformation to the network.

The purpose of this procedure is to inform E-UTRAN or NR MN about an SCG failure that the UE has experienced, and the SCG failure may include:
a) SCG radio link failure;
b) failure of SCG reconfiguration with sync;
c) SCG configuration failure for RRC message on SRB3;
d) SCG integrity check failure; and
e) consistent uplink listen before talk (LBT) failures on PSCell for operation with shared spectrum channel access.

Failure type, measurement results in MCG and measurement results in SCG can be included in the SCG Failure Information message. After the network receives the SCG Failure Information message, it may trigger the UE to perform SN release, SN modification, or SN change.

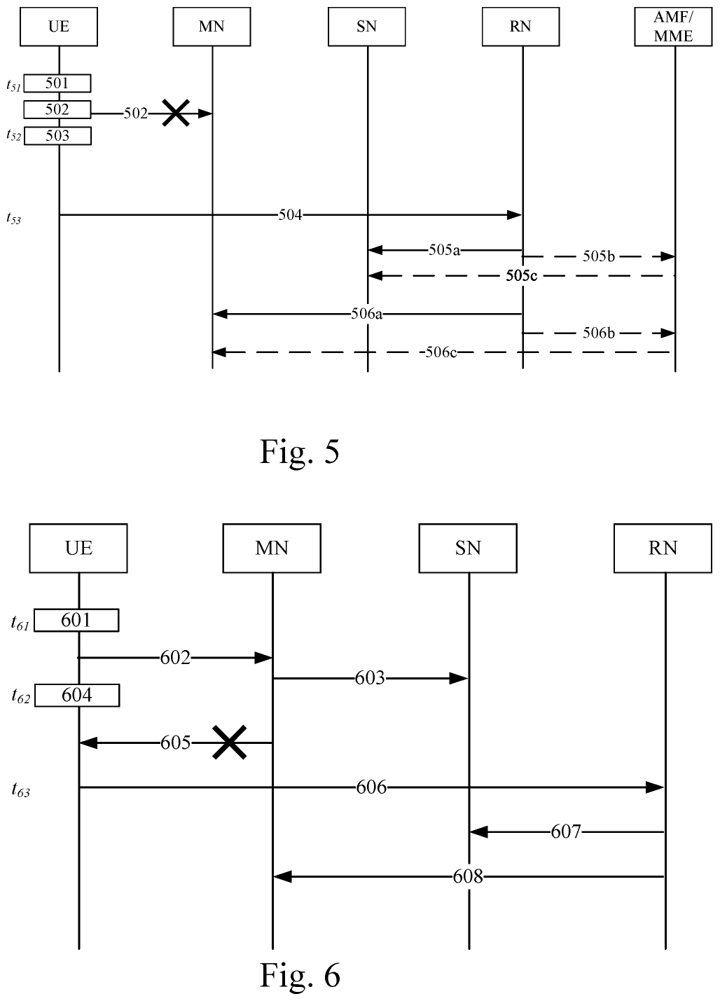

FIG. 5 illustrates another flow chart for reporting event related information according to some embodiments of the present disclosure.

FIG. 5 describes the first event scenario according to the present disclosure, which is:

Scenario 1: the UE detects the first event, e.g. the SCG failure in SN, then it tries to send the SCGFailureInformation message to the MN, but the second event, e.g. the MCG failure occurs before the SCGFailureInformation message is sent to the MN successfully or before the SCGFailureInformation message is received by the MN successfully, thus the UE performs RRC re-establishment.

FIG. 5 includes 6 different entities, the UE, the MN, which represents the master node, the SN, which represents the secondary node, the RN, which represents the re-establishment network node, the mobility management entity (MME), and access and mobility management function (AMF).

In step 501, the UE detects the first event, e.g. SCG failure at the time point t₅₁. In step 502, the UE stores the SCG failure related information, and decides/tries to transmit it to MN.

Before the SCG failure information is transmitted to the MN or successfully received by the MN, in step 503, the UE detects the second event, e.g. MCG failure at the time point t₅₂, and then the UE stores MCG failure related information.

Then the UE performs the RRC re-establishment procedure, and re-connects to the RN after both the SCG failure and the MCG failure. The RN may be a node different from the MN or the SN. In some other scenarios, the RN may be the MN or the SN.

The UE may transmit a message to the RN, to inform the RN that the UE has stored the event related information. In the present disclosure, the event may refer to any of the following events related to the SCG or MCG:
a) SCG failure;
b) MCG failure;
c) an ongoing RACH procedure from a source PSCell to a target PSCell being stopped due to the MCG failure;
d) a PSCell change failure occurred during a PSCell change procedure; or
e) an SCG failure occurred shortly after a successful PSCell change from the source PSCell to the target PSCell.

Accordingly, the event related information refers to the information relates to one or more of the above events. The event related information may also be referred to as failure related information, a radio link failure (RLF) report, or the like, and the present disclosure has no intention of restricting this expression of the event related information.

After receiving this message, the RN may request to UE to transmit the event related information to the RN, and in step 504, the UE transmits the event related information to the RN, the event related information may be reported by a RLF report or a RRC message, and at least include the following:
1) failed PSCell ID, that is, the ID of the cell to which the UE is accessed when the SCG failure happens. It is used to indicate the PSCell in which RLF is detected or the target PSCell of the failed PSCell change. For example, the failed PSCell ID may be physical cell identity (PCI) together with frequency information, and/or cell global identity (CGI).
2) The type of the first event, i.e. SCG failure type.
   Hereinafter in the present disclosure, the SCG failure type may include:
   a) 1310-Expiry, that is, the expiry of timer T310 for SCG.
   b) randomAccessProblem, that is, a random access (RA) problem in SCG.
   c) rlc-MaxNumRetx, that is, max radio link control (RLC) retransmission is reached in SCG.
   d) synchReconfigFailureSCG, that is, reconfiguration with sync failure of the SCG.
   e) scg-ReconfigFailure, that is, reconfiguration for SCG fails.
   f) srb3-IntegrityFailure, that is, integrity protection/check for SRB3 fails.
   g) scg-lbtFailure, that is, LBT failure or consistent LBT failure happens in PSCell or SCG,
   h) beamFailureRecoveryFailure, that is, beam failure recovery failure in SCG.
   i) 1312-Expiry, that is, the expiry of timer T312 for SCG.
   j) bh-RLF, that is, the radio link failure occurs in backhaul link of SCG.
3) failed PCell ID, that is, the ID of the cell to which the UE is accessed when the MCG failure happens. It is used to indicate the PCell in which RLF is detected or the target PCell of the failed PCell change. For example, the failed PCell ID may be PCI together with frequency information, and/or CGI.
4) The type of the second event, i.e. MCG failure type.
   Hereinafter in the present disclosure, the MCG failure type may include:
   a) 1310-Expiry, that is, the expiry of timer T310 for MCG.
   b) randomAccessProblem, that is, a RA problem in MCG.
   c) rlc-MaxNumRetx, that is, max RLC retransmission is reached in MCG.
   d) 1312-Expiry, that is, the expiry of timer T312 for MCG.
   e) IbtFailure, that is, LBT failure or consistent LBT failure happens in PCell or MCG.
   f) beamFailureRecoveryFailure, that is, beam Failure Recovery Failure in MCG.
   g) bh-RLF, that is, the backhaul Radio Link Failure occurs in backhaul link of MCG.
5) time elapsed from the time point when the first event (i.e. SCG failure) happens to the time point when the second event (i.e. MCG failure) happens.
   This parameter may also be referred to as the time elapsed since the SCG failure until the MCG failure, or the time duration/period between the SCG failure happens and the MCG failure happens. As shown in FIG. 5, this parameter is the time duration from t₅₁ to t₅₂.
6) time elapsed from the time point when the second event (i.e. MCG failure) happens to the time point that the UE reports event related information.
   This parameter may also be referred to as the time elapsed since the MCG failure until reporting the event related information, or the time duration/period from the MCG failure happens to reporting the event related information. As shown in FIG. 5, this parameter is the time duration from 152 to 153.
7) measurement results for the MCG and/or the source SCG when SCG failure happens and/or MCG failure happens. For example, the measurement results may be the reference signal received power (RSRP) for the MCG and/or the source SCG when SCG failure happens and/or MCG failure happens.

Alternatively, the UE may transmit the event related information to the RN during the re-establishment procedure with the RN.

The UE may use a new defined message to transmit the event related information to the RN, or the UE may use the UE Information Response, to transmit the event related information.

After receiving the event related information, the RN may transfer the event related information to the MN (step 506a) and to the SN (step 505a) separately via existing message or a new defined message, for example, the RN may reuse the existing message, such as FAILURE INDICATION, to transfer the event related information to the MN and to the SN separately

In some other scenarios, if the RN is the MN, then the MN transmits the event related information to the SN; and if the RN is the SN, then the SN transmits the event related information to the MN.

The transmission of the event related information from the RN to MN or SN may be via Xn or X2 interface between two RAN nodes. When there is no direct Xn or X2 interface between two RAN nodes, then the event related information may be transferred via S1 or NG interface, such as AMF or MME.

For example, if the involved RAN nodes (RN or MN or SN) connect AMF, an existing message e.g. Uplink RAN Configuration Transfer message or a new message can be used to transfer the event related information (the event related information may be regarded as a container included in the Uplink RAN Configuration Transfer message) from a RAN node to the AMF, and an existing message (e.g. Downlink RAN Configuration Transfer message) or a new message may be used to transfer the event related information from the AMF to a RAN node (the event related information may be regarded as a container included in the Downlink RAN Configuration Transfer message).

For another example, if the involved RAN nodes (RN or MN or SN) connect MME, an existing message, e.g. eNB CONFIGURATION TRANSFER message, or a new message can be used to transfer the event related information from a RAN node to the MME (for example, the event related information may be considered as a container included in the eNB CONFIGURATION TRANSFER message), and an existing message e.g. MME CONFIGURATION TRANSFER message or a new message may be used to transfer the event related information from the MME to a RAN node (the event related information may be regarded as a container included in the MME CONFIGURATION TRANSFER message).

Accordingly, if the RN is a different node from the MN or the SN, and there is no direct Xn or X2 interface between the RN and the MN, and if both RN, SN and MN connect AMF, in step 506b, the RN may transfer the event related information to the AMF via an existing message, e.g. Uplink RAN Configuration Transfer message or a new message, then in step 506c, the AMF may transfer the event related information to the MN via an existing message e.g. Downlink RAN Configuration Transfer message or a new message. Similarly, in step 505b, the RN may transfer the event related information to the AMF, and in step 505c, the AMF may transfer the event related information to the SN. In some embodiments, the step 505b and the step 506b may be the same step. For instance, in step 505b (or 506b), the RN may transfer the event related information to the AMF, and the AMF transfers the event related information to the MN in step 506c or the SN in step 505c.

Alternatively, if the RN is a different node from the MN or the SN, and there is no direct Xn or X2 interface between the RN and the MN, and if both RN, SN and MN connect MME, in step 506b, the RN may transfer the event related information to the MME via an existing message, e.g. eNB CONFIGURATION TRANSFER or a new message, then in step 506c, the MME may transfer the event related information to the MN via an existing message e.g. MME CONFIGURATION TRANSFER message or a new message. Similarly, in step 505b, the RN may transfer the event related information to the MME, and in step 505c, the MME may transfer the event related information to the SN. In some embodiments, the step 505b and the step 506b may be the same step. For instance, in step 505b (or 506b), the RN may transfer the event related information to the MME, and the MME transfers the event related information to the MN in step 506c or the SN in step 505c.

After the MN receives the event related information, it may make analysis for the MCG and/or SCG failure and may optimize MN and/or SN related configuration, for example:
a) MCG signalling radio bearer (SRB) configuration;
b) MCG data radio bearer (DRB) configuration;
c) a threshold for triggering PCell change or PCell modification; and/or
d) a threshold for triggering PSCell change or PSCell modification or PSCell release.

After the SN receives the event related information, it may also make analysis for the SCG failure and may optimize SN related configuration, for example:
a) SRB configuration;
b) DRB configuration;
c) a threshold for triggering PSCell change or PSCell modification or PSCell release; and/or
d) RACH configuration for target PSCell.

FIG. 6 illustrates still another flow chart for reporting event related information according to some embodiments of the present disclosure.

FIG. 6 describes the second event scenario according to the present disclosure, which is:

Scenario 2: the UE sends the SCGFailureInformation to the MN when it detects the first event, e.g. SCG failure in SN. After the MN receives the SCGFailureInformation message, it triggers S-SN release, S-SN modification, or SN change, but before the RRC reconfiguration message for S-SN release or S-SN modification or SN change is sent to the UE, the UE detects the second event, e.g. MCG failure, thus the UE performs RRC re-establishment.

FIG. 6 includes 4 different entities, the UE, the MN, the SN, and the RN. FIG. 6 may further include the AMF/MME (not shown in FIG. 6), which is used for transmitting the event related information between the nodes with similar operations as explained in operations 505b, 505c, 506b, and 506c in FIG. 5.

In step 601, the UE detects the first event, e.g. SCG failure at the time point t₆₁. In step 602, the UE transmits the information for SCG failure to MN. The information for SCG failure may be transmitted by the SCGFailureInformation message.

After the MN receives the SCGFailureInformation message, the MN transmits the information in the SCGFailureInformation message to the SN, and also triggers S-SN release, S-SN modification, or SN change for the UE. Then, the MN tries to transmit the RRC reconfiguration message for S-SN release or S-SN modification or SN change to the UE in step 605, however, the UE detects the second event, e.g. the MCG failure in step 604 at the time point t₆₂, which is before the time when the RRC reconfiguration message sent by the MN is successfully received by the UE, then the UE stores MCG failure related information.

Then the UE performs the RRC re-establishment procedure, and re-connects to the RN after both the SCG failure and the MCG failure. The RN may be a node different from the MN or the SN. In some other scenarios, the RN may be the MN, or the SN.

The UE may transmit a message to the RN, to inform the RN that the UE has stored the event related information. After receiving this message, the RN may request to UE to transmit the event related information to the RN, and in step 606 at the time point 163, the UE transmits the event related information to the RN, the event related information may be reported by a RLF report or a RRC message, and at least include the following:
1) failed PCell ID.
2) the type of the second event, i.e. MCG failure type (please refer to the description related to FIG. 5 for detailed MCG failure type).
3) time elapsed from the time point when the first event (i.e. SCG failure) happens to the time point when the second event (i.e. MCG failure) happens.
   This parameter may also be referred to as the time duration since the SCG failure until the MCG failure happens, or the time period from the SCG failure happens to the MCG failure happens. As shown in FIG. 6, this parameter is the time duration from t₆₁ to t₆₂.
4) time elapsed from the time point when the second event (i.e. MCG failure) happens to the time point that the UE reports event related information.
   This parameter may also be referred to as the time duration since the MCG failure until reporting event related information, or the time period from the MCG failure happens to reporting event related information. As shown in FIG. 6, this parameter is the time duration from t₆₂ to t₆₃.
5) measurement results for the MCG and/or the source SCG when SCG failure happens and/or MCG failure happens. For example, the measurement results may be the RSRP for the MCG and/or the source SCG when SCG failure happens and/or MCG failure happens.

The UE may use a new defined message to transmit the event related information to the RN, or the UE may use the UE Information Response, to transmit the event related information.

Since the UE has transmitted the information for SCG failure to MN in step 602, thus the event related information does not include the SCG failure related information, i.e. the failed PSCell ID and the type of the first event, i.e. SCG failure type (please refer to the description related to FIG. 5 for detailed SCG failure type). Alternatively, the event related information may still include the failed PSCell ID and the SCG failure type.

In step 607, the RN transmits the event related information to SN. If there is no direct interface, the RN may transmit the event related information to SN via AMF or MME with similar operations as explained in steps 505b and 505c in FIG. 5, if there is a direct interface, the RN may transmit the event related information to SN, e.g. reuse the existing message, such as FAILURE INDICATION. In step 608, the RN transmits the event related information to MN, for example, if there is no direct interface, the RN may transmit the event related information to MN via AMF or MME with similar operations as explained in steps 506b and 506c in FIG. 5, if there is a direct interface, the RN may transmit the event related information to MN, e.g. reuse the existing message, such as FAILURE INDICATION.

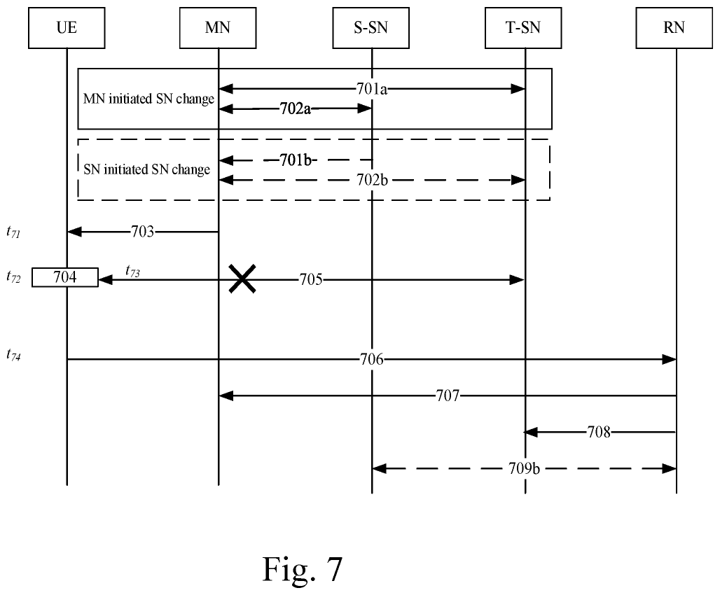

FIG. 7 illustrates yet another flow chart for reporting event related information according to some embodiments of the present disclosure.

FIG. 7 describes the third event scenario according to the present disclosure, which is:

Scenario 3: the UE detects the second event, e.g. the MCG failure, occurs during RACH towards the target PSCell, so the first event occurs, e.g. RACH procedure towards the target PSCell or SN change procedure is stopped when the MCG failure occurs, and the UE performs RRC re-establishment.

FIG. 7 includes 5 different entities, the UE, the MN, the S-SN, which represents the source SN, the T-SN, which represents the target SN, and the RN. FIG. 7 may further include the AMF/MME (not shown in FIG. 7), which is used for transmitting the event related information between the nodes with similar operations as explained in operations 505b, 505c, 506b, and 506c in FIG. 5.

Two types of SN change are included in FIG. 7, i.e. FIG. 7 illustrates mobility robustness optimization (MRO) for Scenario 3 in MN initiated SN change or SN initiated SN change. Steps 701a, 702a, and 703-708 relate to MN initiated SN change. Steps 701b, 702b, 703-708, and 709b relate to SN initiated SN change.

Specifically, for the SN change initiated by the MN, in step 701a, the MN performs SN Addition procedure with the T-SN, i.e. the MN initiates the SN change by transmitting a SN addition request to the target SN, which requests the target SN to allocate resources for the UE, then T-SN transmits a SN addition request ACK to the MN. The MN may include measurement results related to the target SN. In step 702a, the MN transmits a SN Release request to the source SN, to release the source SN resources, which also includes a cause indicating SCG mobility. The source SN transmits an ACK to the SN release request. The reception of the SN release request message triggers the source SN to stop providing user data to the UE.

For the SN change initiated by the SN, in step 701b, the source SN initiates the SN change procedure by sending the SN change required message to the MN, which contains a candidate target node ID, i.e., the ID of the target SN, and may include the SCG configuration, to support delta configuration, and measurement results related to the target SN. In step 702b, the MN requests the target SN to allocate resources for the UE by transmitting a SN addition request to the target SN, which includes the measurement results related to the target SN received from the source SN. The target SN transmits an ACK to the SN addition request to the MN. If data forwarding is needed, the target SN provides data forwarding addresses to the MN. The target SN includes the indication of the full or delta RRC configuration.

In step 703, the MN transmits the RRC message for SN change to the UE, and the UE receives the RRC message at the time point 171. After receiving the RRC message, the UE performs a RACH procedure towards the target PSCell, or performs a SN change procedure.

In step 704, the UE detects the second event, i.e. the MCG failure at the time point t₇₂, then the UE may store MCG failure related information. Upon the MCG failure occurs, the RACH procedure (step 705) towards the target PSCell or SN change procedure is stopped at the time point t₇₃, and the UE may store PSCell or SN change related information

Then the UE performs the RRC re-establishment procedure, and reconnects to the RN after the MCG failure during the SN change procedure. The RN may be a node different from the MN or the SN. In some other scenarios, the RN may be the MN, or the SN.

The UE may transmit a message to the RN, to inform the RN that the UE has stored the event related information. After receiving this message, the RN may request to UE to transmit the event related information to the RN, and in step 706, the UE transmits the event related information to the RN, the event related information may be reported by a RLF report or a RRC message, and at least include the following:
a) failed PCell ID (please refer to the description related to FIG. 5 for detailed failed PCell ID);
b) the type of the second event, i.e. MCG failure type (please refer to the description related to FIG. 5 for detailed MCG failure type);
c) previous PSCell ID, it used to indicate the source PSCell of the last PSCell change (source PSCell when the last RRC Reconfiguration message for PSCell/SN change was received), e.g. PCI together with frequency information, and/or CGI.
d) target PSCell ID where RACH or SN change procedure is stopped (e.g. PCI together with frequency information, and/or CGI);
e) the type of the first event e.g. RACH towards the target PSCell or SN change procedure is stopped, or an indication indicates that RACH towards the target PSCell or SN change procedure is stopped;
f) time elapsed from receiving RRC message for SN or PSCell change to the second event (i.e. MCG failure) happens.
   This parameter may also be referred to as the time duration since receiving the RRC message until the MCG failure, or the time period from receiving the RRC message to the MCG failure happens. As shown in FIG. 7, this parameter is the time duration from the t₇₇ to t₇₂;
g) time elapsed from the second event (i.e. MCG failure) to the first event (i.e. RACH towards the target PSCell or SN change procedure is stopped).
   As shown in FIG. 7, this parameter is the time duration from the t₇₂ to t₇₃. In some cases, MCG failure and stopping RACH towards the target PSCell or SN change procedure happened at the same moment, and time t₇₂ and time t₇₃ are the same time, thus the time duration from the t₇₂ to t₇₃ is zero, or this time information cannot be stored or reported.
h) time elapsed from the first event (i.e. RACH towards the target PSCell or SN change procedure is stopped) to reporting event related information.
   As shown in FIG. 7, this parameter is the time duration from the t₇₃ to t₇₄. In some cases, time duration from the t₇₂ to t₇₃ is zero, then this time duration may also be time duration from the t₇₂ to t₇₄, i.e. time elapsed from MCG failure to reporting event related information.
i) measurement results for the MCG and/or the source SCG when MCG failure happens and/or RACH towards the target PSCell or SN change procedure is stopped. For example, the measurement results may be the RSRP for the MCG and/or the source SCG when MCG failure happens and/or RACH towards the target PSCell or SN change procedure is stopped.

The UE may use a new defined message to transmit the event related information to the RN, or the UE may use the UE Information Response, to transmit the event related information.

In step 707, the RN transmits the event related information to MN. If there is no direct interface between the RN and the MN, the RN may also transmit the event related information to MN via AMF or MME with similar operations as explained in steps 506b and 506c in FIG. 5. If there is a direct interface, the RN may transmit the event related information to MN, e.g. reuse the existing message, such as FAILURE INDICATION.

In step 708, the RN transmits the event related information to T-SN. If there is no direct interface, the RN may transmit the event related information to T-SN via AMF or MME with similar operations as explained in steps 505b and 505c in FIG. 5. If there is a direct interface, the RN may transmit the event related information to T-SN, e.g. reuse the existing message, such as FAILURE INDICATION.

For SN initiated SN change, the RN may also transmit the event related information to S-SN. If there is no direct interface, the RN may also transmit the event related information to S-SN via AMF or MME with similar operations as explained in steps 505b and 505c in FIG. 5. If there is a direct interface, the RN may transmit the event related information to S-SN, e.g. reuse the existing message, such as FAILURE INDICATION.

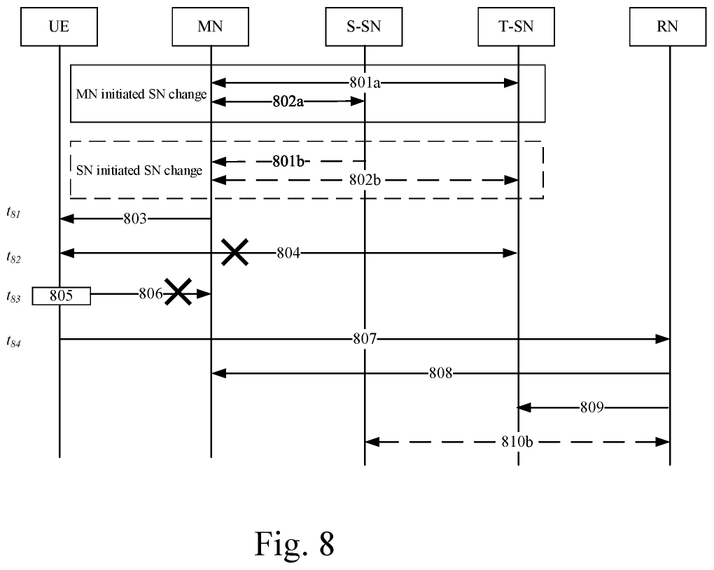

FIG. 8 illustrates yet another flow chart for reporting event related information according to some embodiments of the present disclosure.

FIG. 8 describes the fourth event scenario according to the present disclosure, which is:

Scenario 4: the UE detects the first event e.g. an SCG failure occurs shortly after a successful PSCell change from a source PSCell to a target PSCell (i.e. SCG failure), or a PSCell change failure occurs during the PSCell change procedure (i.e. PSCell or SN change failure), then the UE tries to send the SCGFailureInformation message to the MN, but the second event occurs, e.g. the MCG failure occurs before the SCGFailureInformation message is sent or sent to the MN successfully, so the UE performs RRC re-establishment.

FIG. 8 includes 5 different entities, the UE, the MN, the S-SN, the T-SN, and the RN. FIG. 8 may further include the AMF/MME (not shown in FIG. 8), which is used for transmitting the event related information between the nodes with similar operations as explained in operations 505b, 505c, 506b, and 506c in FIG. 5.

Two types of SN change are included in FIG. 8, i.e. FIG. 8 illustrates MRO for Scenario 4 in MN initiated SN change or SN initiated SN change. Steps 801a, 802a, and 803-809 relate to MN initiated SN change. Steps 801b, 802b, 803-808, and 810b relate to SN initiated SN change.

The operations in steps 801a, 802a, 801b, and 802b are similar to the steps 701a, 702a, 701b, and 702b in FIG. 7, please refer to the description in FIG. 7 for details.

In step 803, the MN transmits the RRC message for SN change to the UE, and the UE receives the RRC message at the time point t₈₁. After receiving the RRC message, the UE performs a RACH procedure towards the target PSCell, or performs a SN change procedure.

In step 804 at the time point t₈₂, the UE detects the first event, e.g. an SCG failure occurs shortly after a successful PSCell change from a source PSCell to a target PSCell; or in step 804 at the time point t₈₂, the UE detects a PSCell change failure occurs during the PSCell change procedure, then the UE may store SCG failure related information.

Then the UE tries to send the SCGFailureInformation message, which includes the SCG failure related information, to the MN in step 806, but in step 805 at the time point 183, the second event, e.g. MCG failure occurs before the SCGFailureInformation message is sent to the MN successfully, and the UE may store MCG failure related information. Then the UE performs the RRC re-establishment procedure, and re-connects to the RN after the MCG failure. The RN may be a node different from the MN or the SN. In some other scenarios, the RN may be the MN, or the SN.

The UE may transmit a message to the RN, to inform the RN that the UE has stored the event related information. After receiving this message, the RN may request to UE to transmit the event related information to the RN, and in step 807 at the time point t₈₄, the UE transmits the event related information to the RN, the event related information may be reported by a RLF report or a RRC message, and at least include the following:
a) the previous PSCell ID (please refer to the description related to FIG. 7 for detailed previous PSCell ID);
b) failed PSCell ID (please refer to the description related to FIG. 5 for detailed failed PSCell ID);
c) the type of the first event, i.e. SCG failure type (please refer to the description related to FIG. 5 for detailed SCG failure type);
d) failed PCell ID (please refer to the description related to FIG. 5 for detailed failed PCell ID);
e) the type of the second event, i.e. MCG failure type (please refer to the description related to FIG. 5 for detailed MCG failure type);
f) time elapsed from receiving RRC message for SN or PSCell change to the first event (i.e. PSCell/SN change failure or SCG failure).
   This parameter may also be referred to as the time duration since receiving the RRC message until the PSCell/SN change failure or SCG failure, or the time period from receiving the RRC message to the PSCell/SN change failure or SCG failure happens. As shown in FIG. 8, this parameter is the time duration from the t₈₁ to t₈₂.
g) time elapsed from the first event (i.e. PSCell or SN change failure or the SCG failure) to the second event (i.e. MCG failure).
   This parameter may also be referred to as the time duration since PSCell/SN change failure or SCG failure until the MCG failure, or the time period between PSCell/SN change failure or SCG failure happens and the MCG failure happens. As shown in FIG. 8, this parameter is the time duration from the t₈₂ to t₈₃.
h) time elapsed from the second event (i.e. MCG failure) to reporting event related information.
   This parameter may also be referred to as the time duration since the MCG failure until reporting event related information, or the time period from the MCG failure happens to reporting event related information. As shown in FIG. 8, this parameter is the time duration from the t₈₃ to t₈₄.
i) measurement results for the MCG and/or the source SCG when MCG failure happens and/or PSCell/SN change failure/SCG failure. For example, the measurement results may be the RSRP for the MCG and/or the source SCG when MCG failure happens and/or PSCell/SN change failure/SCG failure.

The UE may use a new defined message to transmit the event related information to the RN, or the UE may use the UE Information Response, to transmit the event related information.

After receiving the event related information, the RN may transfer the event related information to the MN (step 808), and/or the T-SN (step 809), and/or the S-SN (step 810b) separately via existing message or a new defined message, for example, the UE may reuse the existing message FAILURE INDICATION. If there is no direct interface between the RN and the MN, the RN may also transmit the event related information to MN, T-SN, or S-SN via AMF or MME with similar operations as explained in steps 506b and 506c in FIG. 5. If there is a direct interface, the RN may transmit the event related information to MN, T-SN, or S-SN, e.g. reuse the existing message, such as FAILURE INDICATION.

In some other scenarios, if the RN is the MN, then the MN transmits the event related information to the T-SN and S-SN; and if the RN is the T-SN (or S-SN), then the T-SN (or S-SN) transmits the event related information to the MN and the S-SN (or T-SN).

The transmission of the event related information from the RN to MN or S-SN or T-SN may be via Xn or X2 interface between two RAN nodes. When there is no Xn or X2 interface between two RAN nodes, then the event related information may be transferred via S1 or NG interface, such as AMF or MME.

In view of the above, self-organizing networks (SON) for both the MCG failure and the PSCell change failure or the SCG failure in MR-DC is considered, and the reliability for MR-DC is improved.

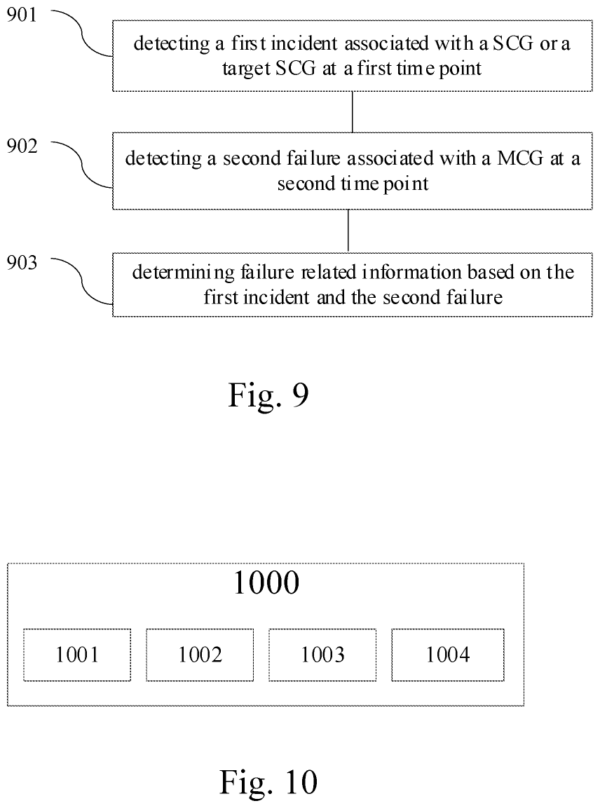

FIG. 9 illustrates a method performed by a UE for reporting event related information according to some embodiments of the present disclosure.

In step 901, the UE detects a first event associated with a SCG or a target SCG; in operation 902, the UE detects a second event associated with a MCG; and in step 903, the UE stores event related information associated with the first event and the second event for transmission to the network. For example, as shown in FIG. 5, the UE detects the SCG failure in step 501, the UE detects the MCG failure in step 502, and the UE stores event related information based on the SCG failure and the MCG failure.

The UE then initiates an RRC re-establishment procedure towards a RN, and transmits the event related information to the RN.

In some embodiment, the first event is SCG failure, and the second event is MCG failure. The event related information at least includes the following parameters: an identifier of a failed primary cell (PCell) in the MCG, a type of the second event, a first time period from an occurrence of the first event to an occurrence of the second event (for example, the time period from t₅₁ to t₅₂ in FIG. 5); a second time period from the occurrence of the second event to transmission of the event related information (for example, the time period from t₅₂ to t₅₃ in FIG. 5); and measurement results for the MCG and/or the source SCG when the first event and/or the second event are detected. In some embodiment, the event related information further includes an identifier of a failed PSCell in the source SCG and a type of the first event.

In some embodiment, the UE may further receive a RRC message for PSCell change before an occurrence of the first event and/or an occurrence of the second event. For example, in FIG. 7, the UE receives a RRC message at the time point 177, which precedes the occurrence of the first event (at the time point 173) and the occurrence of the second event (at the time point 172). In FIG. 7, the second event is MCG failure, the first event is an ongoing RACH procedure from a source PSCell to a target PSCell being stopped due to the second event (i.e. MCG failure).

In this case, the event related information at least includes the following parameters: an identifier of a failed primary cell (PCell) in the MCG; a type of the second event; an identifier of the source PSCell; an identifier of the target PSCell; an indication indicating the RACH procedure is stopped; a third time period from reception of the RRC message to the occurrence of the second event; a fourth time period from the occurrence of the second event to the occurrence of the first event; a fifth time period from the occurrence of the first event to transmission of the event related information; and measurement results for the MCG and/or the source SCG when the first event and/or the second event are detected. Take the scenarios in FIG. 7 as an example, the event related information at least includes: an identifier of a failed PCell in the MCG, a type of the second event, e.g. t310-Expiry, an identifier of the source PSCell; an identifier of the target PSCell; an indication indicating the RACH procedure is stopped; a third time period from t₇₁ to t₇₂; a fourth time period from t₇₂ to t₇₃; a fifth time period from t₇₃ to t₇₄, and RSRP for the MCG and/or the source SCG when the first event and/or the second event are detected.

In some other embodiment, the first event is a PSCell change failure occurred during a PSCell change procedure, or an SCG failure occurred shortly after a successful PSCell change from the source PSCell to the target PSCell, and the second event is MCG failure. In this case, the event related information at least includes the following parameters: an identifier of a failed PCell in the MCG, a type of the second event, an identifier of the source PSCell; an identifier of the failed PSCell; a type of the first event, e.g. failure associated with the source SCG or failure associated with the target SCG; a sixth time period from the reception of the RRC message to the occurrence of the first event; a seventh time period from the occurrence of the first event to the occurrence of the second event; an eighth time period from the occurrence of the second event to transmission of the event related information, and measurement results for the MCG and/or the source SCG when the first event and/or the second event are detected. Take the scenarios in FIG. 8 as an example, the event related information at least includes: an identifier of a failed PCell in the MCG, a type of MCG failure, an identifier of the source PSCell; an identifier of the failed PSCell; a type of SCG failure; a sixth time period from t₈₁ to t₈₂; a seventh time period from t₈₂ to t₈₃; an eighth time period from t₈₃ to t₈₄, and RSRP for the MCG and/or the source SCG when the first event and/or the second event are detected.

In some embodiments, the second event is a failure associated with the MCG.

Correspondingly, at the node side, the node may receive event related information of the UE. The event related information is related to a first event associated with a SCG or a target SCG related to the UE, and is also related to a second event associated with a MCG related to the UE; and modifying one or more SCG configurations associated with the UE, wherein the one or more SCG configurations include at least one of the following: SRB configuration; DRB configuration; a threshold for triggering PSCell change, PSCell modification, or PSCell release; and RACH configuration for target PSCell.

In some embodiments, the node receives the event related information from the RN via interfaces between RAN nodes or via interfaces between RAN nodes and core network. For example, in steps 505b and 505c, the SN receives the event related information from the RN via AMF or MME. If the MN receives the event related information, the MN may modify one or more MCG configurations, and the one or more configurations include at least one of the following: SRB configuration; DRB configuration; a threshold for triggering PCell change or PCell modification.

In some embodiments, if the UE performs the RRC re-establishment procedure, and re-connects to the RN. The RN may transmit the event related information to the MN, T-SN or the S-SN.

In some embodiment, the RN receives the event related information of a user equipment (UE), wherein the event related information is related to a first event associated with a source secondary cell group (SCG) or a target SCG related to the UE, and is also related to a second event associated with a master cell group (MCG) related to the UE; and modifying one or more SCG configurations associated with the UE, wherein the one or more SCG configurations include at least one of the following: signalling radio bearer (SRB) configuration; data radio bearer (DRB) configuration; a threshold for triggering PSCell change, PSCell modification, or PSCell release; and RACH configuration for target PSCell.

FIG. 10 illustrates a block diagram of an apparatus 1000 according to the embodiments of the present disclosure. The apparatus 1000 may include a receiving circuitry, a processor, a medium and a transmitting circuitry. In one embodiment, the apparatus 1000 may include a non-transitory computer-readable medium 1003 having stored thereon computer-executable instructions; a receiving circuitry 1001; a transmitting circuitry 1004; and a processor 1002 coupled to the non-transitory computer-readable medium 1003, the receiving circuitry 1001 and the transmitting circuitry 1004. The computer executable instructions can be programmed to implement a method (e.g. the method in FIG. 9) with the receiving circuitry 1001, the transmitting circuitry 1004 and the processor 1002.

In one embodiment, the apparatus 1000 may include a processor; and a transceiver coupled to the processor, wherein the processor is configured to: detect a first event associated with a source secondary cell group (SCG) or a target SCG; detect a second event associated with a master cell group (MCG); and store event related information associated with the first event and the second event for transmission to the network.

The method of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each Fig. are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

In this disclosure, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

1.-14. (canceled)

15. A user equipment (UE), comprising:
a processor; and
a memory coupled with the processor, the processor configured to cause the UE to:
detect a first event associated with a source secondary cell group (SCG) or a target SCG;
detect a second event associated with a master cell group (MCG); and
store event related information associated with the first event and the second event for transmission to the network.

16. The UE of claim 15, wherein the processor is further configured to cause the UE to:
initiate a radio resource control (RRC) re-establishment procedure towards a re-establishment network node; and
transmit the event related information to the re-establishment network node.

17. The UE of claim 15, wherein the first event is a first failure associated with the source SCG.

18. The UE of claim 17, wherein the event related information includes one or more of the following parameters:
an identifier of a failed primary cell (PCell) in the MCG,
a type of the second event,
a first time period from an occurrence of the first event to an occurrence of the second event;
a second time period from the occurrence of the second event to transmission of the event related information; and
measurement results for the MCG and/or the source SCG when the first event and/or the second event are detected.

19. The UE of claim 15, wherein the event related information further includes an identifier of a failed primary secondary cell (PSCell) in the source SCG and a type of the first event.

20. The UE of claim 15, wherein the processor is further configured to cause the UE to:
receive an RRC message for primary secondary cell (PSCell) change before an occurrence of the first event and/or an occurrence of the second event.

21. The UE of claim 20, wherein the first event is an ongoing random access channel (RACH) procedure from a source PSCell to a target PSCell being stopped due to the second event.

22. The UE of claim 21, wherein the event related information includes one or more of the following parameters:
an identifier of a failed primary cell (PCell) in the MCG;
a type of the second event;
an identifier of the source PSCell;
an identifier of the target PSCell;
an indication indicating the RACH procedure is stopped;
a third time period from reception of the RRC message to the occurrence of the second event;
a fourth time period from the occurrence of the second event to the occurrence of the first event;
a fifth time period from the occurrence of the first event to transmission of the event related information; and
measurement results for the MCG and/or the source SCG when the first event and/or the second event are detected.

23. The UE of claim 20, wherein the first event is a PSCell change failure occurred during a PSCell change procedure, or an SCG failure occurred shortly after a successful PSCell change from the source PSCell to the target PSCell.

24. The UE of claim 23, wherein the event related information includes one or more of the following parameters:
an identifier of a failed primary cell (PCell) in the MCG;
a type of the second event;
an identifier of the source PSCell;
an identifier of the failed PSCell;
a type of the first event associated with the target SCG;
a sixth time period from reception of the RRC message to the occurrence of the first event;
a seventh time period from the occurrence of the first event to the occurrence of the second event;
an eighth time period from the occurrence of the second event to transmission of the event related information; and
measurement results for the MCG and/or the source SCG when the first event and/or the second event are detected.

25. The UE of claim 15, wherein the second event is a failure associated with the MCG.

26. A processor for wireless communication, comprising:
at least one controller coupled with at least one memory and configured to cause the processor to:
detect a first event associated with a source secondary cell group (SCG) or a target SCG;
detect a second event associated with a master cell group (MCG); and;
store event related information associated with the first event and the second event for transmission to the network.

27. The processor of claim 26, wherein the controller is further configured to cause the processor to:
initiate a radio resource control (RRC) re-establishment procedure towards a re-establishment network node; and
transmit the event related information to the re-establishment network node.

28. The processor of claim 27, wherein the controller is further configured to cause the processor to:
receive an RRC message for primary secondary cell (PSCell) change before an occurrence of the first event and/or an occurrence of the second event.

29. The processor of claim 26, wherein the first event is a first failure associated with the source SCG.

30. The processor of claim 26, wherein the controller is further configured to cause the processor to:
receive an RRC message for primary secondary cell (PSCell) change before an occurrence of the first event and/or an occurrence of the second event.

31. The processor of claim 26, wherein the second event is a failure associated with the MCG.

32. A network node, comprising:
a processor; and
a memory coupled with the processor, the processor configured to cause the network node to:
receive event related information from a user equipment (UE), wherein the event related information is related to a first event associated with a source secondary cell group (SCG) or a target SCG related to the UE, and is also related to a second event associated with a master cell group (MCG) related to the UE; and
modify one or more SCG configurations associated with the UE, wherein the one or more SCG configurations include at least one of the following:
signaling radio bearer (SRB) configuration;
data radio bearer (DRB) configuration;
a threshold for triggering PSCell change, PSCell modification, or PSCell release; and
RACH configuration for target PSCell.

33. The network node of claim 32, wherein the processor is further configured to cause the network node to:
receive the event related information from a re-establishment network node via interfaces between radio access network (RAN) nodes or via interfaces between RAN nodes and a core network.

34. A network node, comprising:
a processor; and
a memory coupled with the processor, the processor configured to cause the network node to:
receive event related information from a user equipment (UE), wherein the event related information is associated with a first event associated with a source secondary cell group (SCG) or a target SCG related to the UE, and is also associated with a second event associated with a master cell group (MCG) related to the UE; and
transmit the event related information to a first network node that provides the MCG associated with UE, and/or a second network node that provides either the source SCG or the target SCG associated with the UE.
